(19) United States
(12) Patent Application Publication
(10) Pub. No.: US 2011/0208327 A1
(43) Pub. Date: Aug. 25, 2011

(54) SAFETY CONTROLLER HAVING A REMOVABLE DATA STORAGE MEDIUM

(76) Inventors: Rolf DICKHOFF, Kirchheim (DE); Joachim Rink, Esslingen (DE)

(21) Appl. No.: 13/045,979

(22) Filed: Mar. 11, 2011

Related U.S. Application Data
(63) Continuation of application No. PCT/EP2009/005939, filed on Aug. 17, 2009.

(30) Foreign Application Priority Data
Sep. 12, 2008 (DE) 10 2008 047 514.9

(51) Int. Cl. G05B 9/02

(52) U.S. Cl. 700/79

(57) ABSTRACT

A data storage medium has a carrier element configured to carry a memory element. The memory element stores data for configuring or even programming a safety controller. The data storage medium has at least one mounting element which is able to move relative to the carrier elements such that it is able to interact with a holding unit arranged on the safety controller. As a result, the data storage medium can be easily and removably be connected to the safety controller.

### CROSS REFERENCES TO RELATED APPLICATIONS

This application is a continuation of international patent application PCT/EP2009/005939 filed on Aug. 17, 2009 designating the U.S., which international patent application has been published in German language and claims priority from German patent application DE 10 2008 047 514.9 filed on Sep. 12, 2008. The entire contents of these prior applications are incorporated herein by reference.

### BACKGROUND OF THE INVENTION

The present invention relates to a safety controller for failsafely controlling a hazardous machine, and more particularly to such a safety controller having a removable data storage medium.

A safety controller within the context of the present invention is an apparatus or an arrangement which receives input signals supplied by sensors and produces output signals by means of logic combinations and potentially further signal or data processing steps. The output signals are supplied to actuators, which effect specific actions or reactions in the controlled machine based on the input signals. A preferred field of application for such safety controllers is the monitoring of emergency-off pushbuttons, two-hand controllers, protective doors or light grids in the field of machine safety. Such sensors are used in order to safeguard a machine, which presents a hazard to humans or material goods during operation. When a protective door is opened or when the emergency-off pushbutton is operated, a respective signal is produced which is supplied to the safety controller as an input signal. In response, the safety controller controls an actuator to shut down that part of the machine which is presenting the hazard.

In contrast to a “normal” controller, a characteristic of a safety controller is that the safety controller must always ensure a safe state for the installation or machine presenting the hazard, even if a malfunction occurs in the controller or in a device connected to it. High demands are therefore placed on safety controllers in terms of failsafety, which results in considerable complexity for development and manufacture. Usually, safety controllers require special approval by competent supervisory authorities, such as by the professional associations or what is known as “TUV” in Germany, before they are used. The safety controller has to meet prescribed safety standards as set down, by way of example, in the European standard EN 954-1 or a comparable standard, such as standard IEC 61508 or standard EN ISO 13849-1. In the following, a safety controller is therefore understood to mean an apparatus or an arrangement which at least complies with safety category 3 of the first cited European standard.

A programmable safety controller allows the user to define the logic combinations and possibly further signal or data processing steps individually using a piece of software that is typically known as the user program. This results in a great deal of flexibility in comparison with earlier solutions, where the logic combinations were defined by an individual hardware connection of various safety components. By way of example, a user program is often written using a commercially available personal computer (PC) and using special programming software.

A user program written in this way needs to be loaded onto the safety controller on which it is intended to run. That is to say that it needs to be transferred to said safety controller and stored in a memory provided for this purpose. To transfer a user program, particularly after an already existing user program has been modified, the personal computer is usually connected to a data communication interface communicating with the controller. This procedure is sometimes inconvenient, because it requires the programming PC. If a plurality of machines or installations are set up in a building, it is necessary to use software to select that safety controller onto which the user program is intended to be loaded. Furthermore, the transfer of the user program via a bus system requires stringent safety precautions so that failsafe operation of the user program is ensured later.

It would be desirable to transfer user programs and other data required for running the safety controller in a more convenient manner. It would also be desirable to configure pre-programmed safety controllers in a convenient manner.

DE 100 37 003 A1 discloses a data storage medium which is used in a system for checking access authorization in computer-aided control devices for machines or installations. The data storage medium has a memory element which stores the authorization. The memory element operates on the basis of the transponder principle, so that the signal transfer between the data storage medium and a checking device connected to the control device takes place without electrical contact. The data storage medium is introduced into the checking device, which has a key retaining device. The key is fixed by latching means which are arranged in the key retaining device and which interact with the key. To this end, the latching means are in movable form. The key itself has no movable elements which allow it to be fixed or mounted on the checking device.

### SUMMARY OF THE INVENTION

In view of the above, it is an object to provide a safety controller which can be conveniently configured and/or programmed.

It is another object to provide a safety controller which can conveniently connected to the removable data storage medium.

It is yet another object to provide a data storage connection mechanism for a safety controller, which has a simple and low-complexity design.

Accordingly, there is provided a safety controller for controlling a hazardous machine, comprising two redundant processors for processing input signals from external sensors and for generating control signals for external actuators, said two redundant processors being connected to each other in order to monitor each other, an input and output unit for receiving the input signals from said external sensors and for transmitting the control signals to the external actuators, said input and output unit being connected to said redundant processors, a data storage medium having a carrier element which carries a memory element, and having at least one mounting element which is able to move relative to the carrier element, a holding unit for detachably holding the data storage medium, the holding unit having at least one retaining element, and a data transfer unit configured to transfer data to and from the data storage medium, while said data storage medium is held by the holding unit, wherein the mounting element has a latching lug and a securing edge at a distance from said latching lug, and the retaining element has a latching edge and a retaining edge at a distance from said latching edge, with the latching lug being configured to engage behind the latching edge and the retaining edge being configured to support the securing edge in order to establish a form-fit connection for holding the data storage medium by the holding unit in a self-locking manner.

In addition, there is provided a safety controller for controlling a hazardous machine, comprising two redundant processors for processing input signals from external sensors and for generating control signals for external actuators, said two redundant processors being connected to each other in order to monitor each other, an input and output unit for receiving the input signals from said external sensors and for transmitting the control signals to the external actuators, said input and output unit being connected to said redundant processors, a data storage medium having a carrier element which carries a memory element, and having at least one mounting element which is able to move relative to the carrier element, a holding unit for detachably holding the data storage medium, the holding unit having at least two retaining elements arranged at a distance to one another, and a data transfer unit configured to transfer data to and from the data storage medium, while said data storage medium is held by the holding unit, wherein the mounting element is spring-biased in order to establish a force-fit connection when the mounting element is pushed between the at least two retaining elements and abuts against the retaining elements.

Since the data storage medium has a mounting element which can move relative to the carrier element and which can be used to mount the data storage medium on a holding unit, the design of associated controller housings is less complex and hence the manufacture thereof is less expensive than in the case of the known data storage medium. Since the movable mounting element is associated with the data storage medium, the housing does not require elements which protrude beyond the housing contour. Just such elements require additional effort for removal from a mold. Since the manufacture of housings requires large tools or molds, such additional measures are complex and therefore costly. By contrast, if additional measures are implemented on a data storage medium, these result in lower additional costs. The manufacture of the data storage medium requires smaller tools or molds, which is why additional measures are not so complex and hence not so costly. In addition, it is possible to dispense with the subsequent fitting of resilient elements to the housings. These also require costly design measures on the housings, for example the provision of threads.

Furthermore, with regard to the replacement of wearing parts, it is advantageous to fit the movable mounting element to the data storage medium. A mounting element fitted to a data storage medium can more easily be replaced than one fitted in a device housing.

### BRIEF DESCRIPTION OF THE DRAWINGS

Exemplary embodiments of the invention are illustrated in the drawing and are explained in more detail in the description below. In the drawing:

FIG. 1 shows a schematic illustration of a safety controller in which a data storage medium is used;

FIG. 2 shows a schematic illustration of the physical split of the individual components of a safety controller;

FIG. 3 shows a simplified illustration of a housing for a safety controller or for a subcomponent of the safety controller to which a data storage medium is being fitted;

FIG. 4 shows, in figure elements 4a to 4f, various views and sections for a first exemplary embodiment of a data storage medium;

FIG. 5 shows, in figure elements 5a to 5f, various views and sections for a second exemplary embodiment of a data storage medium;

FIG. 6 shows a sectional illustration for a data storage medium based on the first exemplary embodiment in a state in which it has been introduced into a holding unit;

FIG. 7 shows a sectional illustration for a data storage medium based on the second exemplary embodiment in a state in which it has been introduced into a holding unit;

FIG. 8 shows a schematic illustration of a third exemplary embodiment of a data storage medium;

FIG. 9 shows a schematic illustration of a fourth exemplary embodiment of a data storage medium;

FIG. 10 shows a schematic sectional illustration of a data storage medium based on the third exemplary embodiment in a state in which it has been introduced into a holding unit, and

FIG. 11 shows a schematic sectional illustration of a data storage medium based on the fourth exemplary embodiment in a state in which it has been introduced into a holding unit.

### DESCRIPTION OF PREFERRED EMBODIMENTS

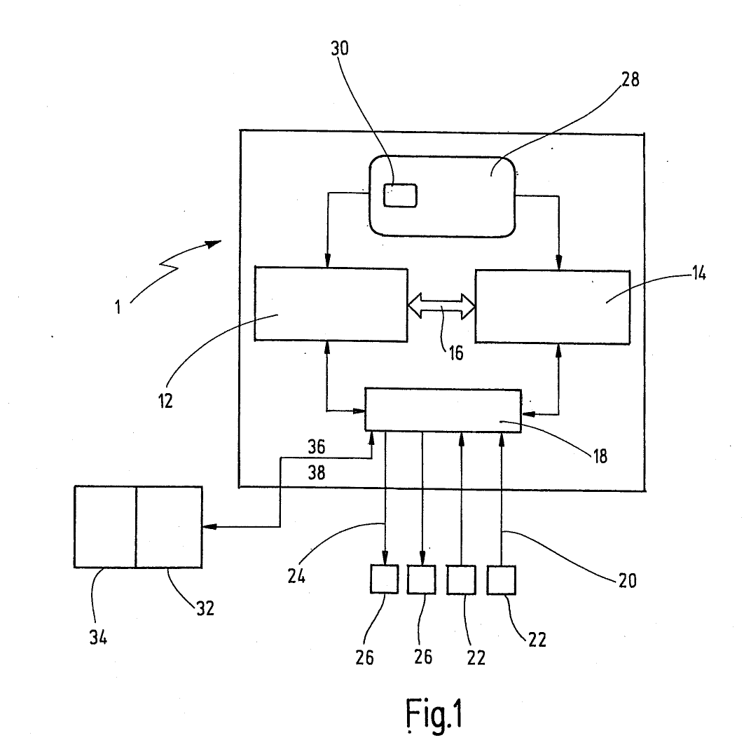

In FIG. 1, a safety controller which is designed to hold a data storage medium is denoted by the reference numeral 1 as a whole.

The safety controller 1 is of two-channel redundant design in order to achieve the requisite failsafety for controlling safety-critical processes. To represent the two-channel design, FIG. 1 shows two separate processors 12, 14 which are connected to one another by means of a bidirectional communication interface 16 in order to be able to monitor one another and interchange data. Preferably, the two channels of the safety controller 1 and the two processors 12, 14 are of a different design in order to prevent systematic faults.

The reference numeral 18 denotes an input/output unit which is connected to each of the two processors 12, 14. The input/output unit picks up input signals 20 from external sensors 22 and forwards them in an adapted data format to each of the two processors 12, 14. In addition, the input/output unit takes the processors 12, 14 as a basis for producing output signals 24 which are used to actuate actuators 26. By way of example, the sensors 22 are emergency-off pushbutton switches, two-hand controllers, protective doors, speed-monitoring appliances or other sensors for picking up safetyrelated parameters. By way of example, the actuators 26 are what are known as contactors, which can be used to shut down the power supply to a drive or to an entire machine.

The reference numeral 28 denotes a memory which is used to store a user program 30. The user program 30 is written using what is known as a programming tool. The user program stipulates the control tasks which are to be performed by the safety controller 1. The memory 28 may be a memory which is permanently installed in the safety controller 1, for example an EEPROM. For reasons of clarity, the aforementioned programming tool is not shown in FIG. 1. For the sake of completeness, however, it should be mentioned that such a programming tool usually contains a conventional PC with a monitor on which a computer program is executed. The computer program allows a user program to be written for a safety controller.

Reference numeral 32 denotes a holding unit on which a data storage medium 34 can be mounted. Data 36 on the data storage medium 34 can then be trans-ferred to the safety controller 1. By way of example, said data 36 may be access authorization data and/or address data and/or a user program and/or maintenance data. In the case of a user program, it is therefore possible for the user program 30 originally in memory 28 to be replaced by the user program on the data storage medium 34. In addition, it is possible for data 38 to be transferred from the safety controller 1 to the data storage medium 34 and stored thereon.

The connection—shown in FIG. 1—of the holding unit 32 and hence the data storage medium 34 to the safety controller 1 by means of the input/output unit 18 is not meant to have any limiting effect. Similarly, a direct connection to the memory 28 is conceivable. By way of example, this may be considered when the data storage medium 34 stores a user program.

When the data storage medium 34 is referred to as being mounted on the holding unit 32, this does not mean that the data storage medium 34, having been fitted to the holding unit 32, remains thereon permanently. On the contrary, the data storage medium 34 is connected to the holding unit 32 detachably.

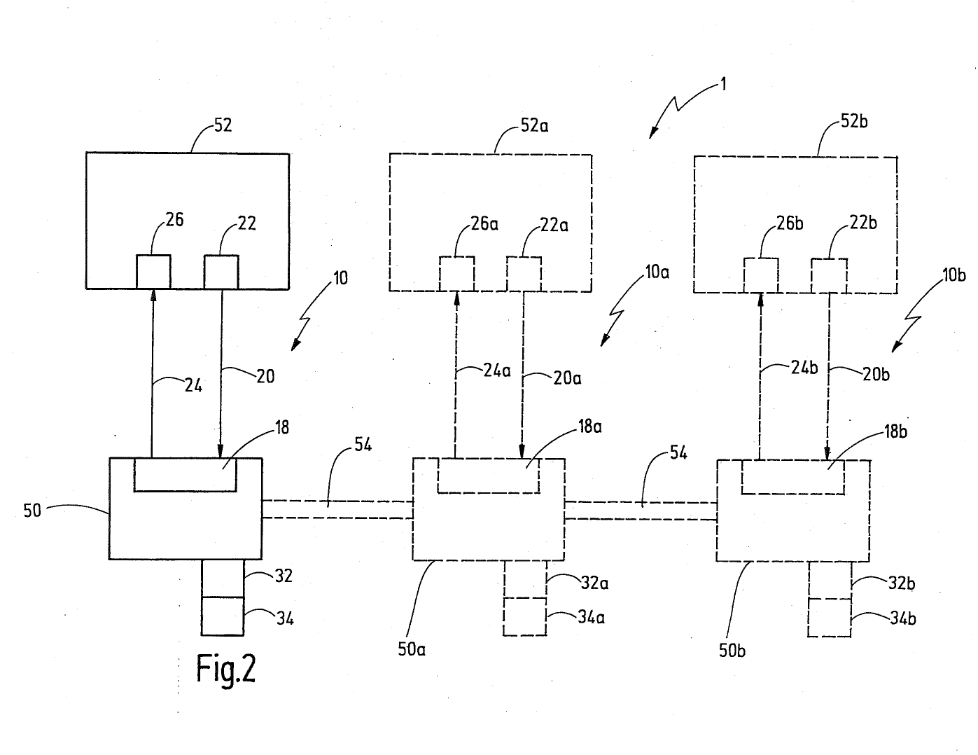

FIG. 2 shows a simplified illustration of the physical arrangement of various components of the safety controller 1. In this case, the following is true: if the safety controller 1 is a single controller, this corresponds to a subcomponent denoted by the reference numeral 10. If the safety controller 1 is of modular design, on the other hand, then it is made up of a plurality of subcomponents 10, 10a, 10b. The chosen illustration with three subcomponents is not intended to have any limiting effect, however. A safety controller may also comprise two or more than three subcomponents. Regardless of the specific form of implementation of the safety controller 12, each of the subcomponents 10, 10a, 10b has the basic functionality which is described in connection with FIG. 1 and which is required for a safety controller.

First of all, a safety controller 1 implemented as a single controller is considered, i.e. the safety controller 1 corresponds to the subcomponent 10. Reference numeral 50 denotes a safety control unit which is used for the safety control of a machine or installation 52. To this end, the sensors 22 arranged in the machine or installation 52 are used to produce signals which are supplied as input signals 20 to the input/output unit 18 arranged in the safety control unit 50. From the input signals 20, the safety control unit 50 produces actuation signals, which are then supplied as output signals 24 via the input/output unit 18 to the actuators 26 arranged in the machine or installation 52. The illustration of the actual control components—these are the components 12, 14, 16, 28 and 30 shown in FIG. 1, which can all be associated with the safety control unit 50—is dispensed with for reasons of clarity. The safety control unit 50 has the associated holding unit 32, which is used to hold the data storage medium 34. The data stored on the data storage medium 34 are transferred to the safety control unit 50 as described in connection with FIG. 1. The data storage medium 34 stores data which describe or influence a state and/or a property of the safety controller 1.

If, by contrast, the safety controller 1 is one of modular design, as is the case with very complex or very large machines or installations, for example, then not only the components described above but also further components—shown in dashed lines in FIG. 2—need to be considered. The safety controller 1 then comprises the subcomponents 10, 10a, 10b; besides the safety control unit 50, further safety control units 50a, 50b exist. The installation or machine to be controlled overall comprises machine subcomponents 52, 52a, 52b. Overall, the following association applies: the safety control unit 50 is associated with the machine subcomponent 52 and undertakes control thereof. The safety control unit 50a is associated with the machine subcomponent 52a and undertakes control thereof. The safety control unit 50b is associated with a machine subcomponent 52b and undertakes control thereof. This is respectively done on the basis of the scheme described above for the safety controller implemented as a single controller. The individual safety control units 50, 50a, 50b are connected to one another via a data transfer unit 54, one of the safety control units 50, 50a, 50b usually taking on the coordinates of all of them. This safety control unit is then called the master, and the others are called slaves. By way of example, the data transfer unit 54 may be a bus system which is usually used for safety controllers. The safety control unit 50a has an associated holding unit 32a for holding a data storage medium 34a, and the safety control unit 50b has an associated holding unit 32b for holding a data storage medium 34b.

The data stored on the data storage medium 34, 34a, 34b describe or affect a state and/or a property of that subcomponent 10, 10a, 10b of the safety controller 1 which has the data storage medium 34, 34a, 34b mounted on its holding unit 32, 32a, 32b. Thus, the data stored on the data storage medium 34 are intended for the safety control unit 50, the data stored on the data storage medium 34a are intended for the safety control unit 50a and the data stored on the data storage medium 34b are intended for the safety control unit 50b. Alternatively, it is conceivable for the data stored on a data storage medium 34, 34a, 34b to be able to influence or be intended for all the subcomponents 10, 10a, 10b and hence all the safety control units 50, 50a, 50b. This is the case when the data are a user program which is stored on the data storage medium of that subcomponent and hence safety control unit which undertakes the coordination of the other subcomponents and safety control units.

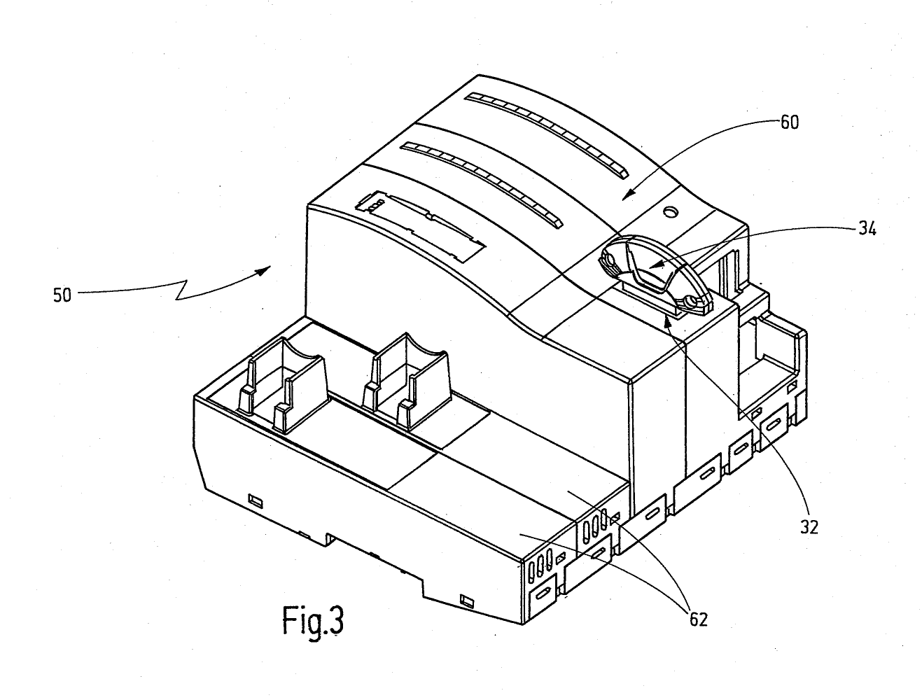

FIG. 3 shows the housing arrangement of the safety control unit 50 shown in FIG. 2. The two other safety control units 50a, 50b shown in FIG. 2 may likewise have this housing arrangement.

The safety control unit 50 is accommodated in a housing 60 which preferably comprises plastic. The housing 60 has a holding unit 32 into which a data storage medium 34 can be introduced and mounted. The data storage medium likewise preferably comprises plastic. The schematic illustration shown in FIG. 3 is not intended to have a limiting effect, for example on the operation of the mounting mechanism which is used to mount the data storage medium 34 on the holding unit 32. The reference numeral 62 denotes further slots, what are known as base modules, which can be used to connect further power-supply or input/output modules to the safety control unit 50, for example.

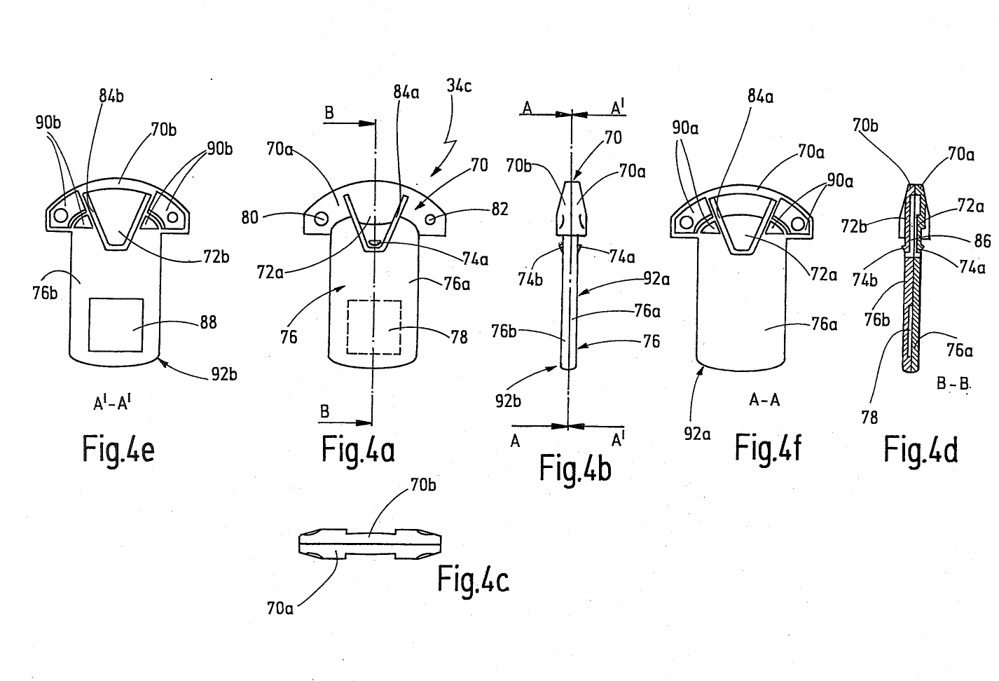

FIG. 4, which comprises the figure elements 4a, 4b, 4c, 4d, 4e, 4f, shows a first exemplary embodiment of the data storage medium by means of various views and sectional illustrations.

Figure element 4a shows a plan view of a data storage medium 34c. The data storage medium 34c has a grip 70, from which figure element 4a shows a grip element 70a. The grip element 70a has a mounting element 72a fitted to it. The mounting element 72a has a latching lug 74a. The data storage medium 34c also has a carrier element 76, from which figure element 4a shows the half 76a which is visible in this illustration. The carrier element 76 encloses a memory element 78. The memory element 78 is a transponder for a non-contact data transfer, for example what is known as an RFID transponder (RFID stands for radio frequency identification). The grip 70 has passage holes 80, 82 which can be used to mount the data storage medium 34c, when required, additionally on the housing of the safety controller, for example using a cable tie or a seal. In addition, the data storage medium 34c can be mounted on a means of transport by means of the passage holes 80, 82 when being transported, for example on the way to the safety controller for which it is intended to be used. In this case, the passage holes 80, 82 may be configured with or without a sleeve. The grip element 70a, the mounting element 72a and the carrier element 76 are in a form such that the mounting element 72a is largely surrounded by a continuous slot 84a such that it is fitted to the grip element 70a so as to be able to move. The mounting element 72a can therefore move relative to the carrier element 76.

Figure element 4b shows the data storage medium 34c in a side view. The data storage medium 34c comprises two shell elements 92a, 92b. The shell element 92 comprises the grip element 70a and the half 76a of the carrier element 76. The shell element 92b comprises the grip element 70b and the half 76b of the carrier element 76. The grip 70 comprises the two grip elements 70a, 70b.

Figure element 4c shows the data storage medium 34c from above, only the two grip elements 70a, 70b being visible in this view on account of the physical design of the data storage medium.

Figure element 4d shows a sectional illustration of the data storage medium 34c along the sectional line B-B shown in figure element 4a. The grip element 70a has the mounting element 72a fitted to it. The grip element 70b has the mounting element 72b fitted to it. The mounting element 72a has the latching lug 74a. The mounting element 72b has a latching lug 74b. Both the two grip elements 70a, 70b and the two mounting elements 72a, 72b are of such design that a cavity 86 is produced between the two mounting elements 72a, 72b. This cavity 86 merges into the slot 84a shown in figure element 4a. On account of the cavity 86, the two mounting elements 72a, 72b can be moved towards one another by applying an appropriate force. The transponder 78 is completely embedded in the half 76b of the carrier element 76.

Figure element 4e shows a plan view of a shell element 92b of the data storage medium 34c. This plan view corresponds to the view from direction A′ onto the sectioned data storage medium 34c when the latter is sectioned along the sectional line shown in figure element 4b. The shell element 92b has the grip element 70b, the mounting element 72b and one half 76b of the carrier element 76. The mounting element 72b is surrounded by a continuous slot 84b, which likewise merges into the cavity 86. The half 76b has a cutout 88 embedded in it which is used to hold the transponder 78. The shell element 92b has depressions 90b in the region of the grip element 70b.

Figure element 4f shows a plan view of a shell element 92a of the data storage medium 34c. This plan view corresponds to the view from direction A onto the sectioned data storage medium 34c when the latter is sectioned along the sectional line shown in figure element 4b. The shell element 92a comprises the grip element 70a, the mounting element 72a and the half 76a of the carrier element 76. The shell element 92a has depressions 90a in the region of the grip element 70a. The mounting element 72a is surrounded by the continuous slot 84a. When the two shell elements 92a, 92b are joined, the depressions 90a, 90b produce cavities. Overall, less material is thus required for manufacturing the data storage medium 34c.

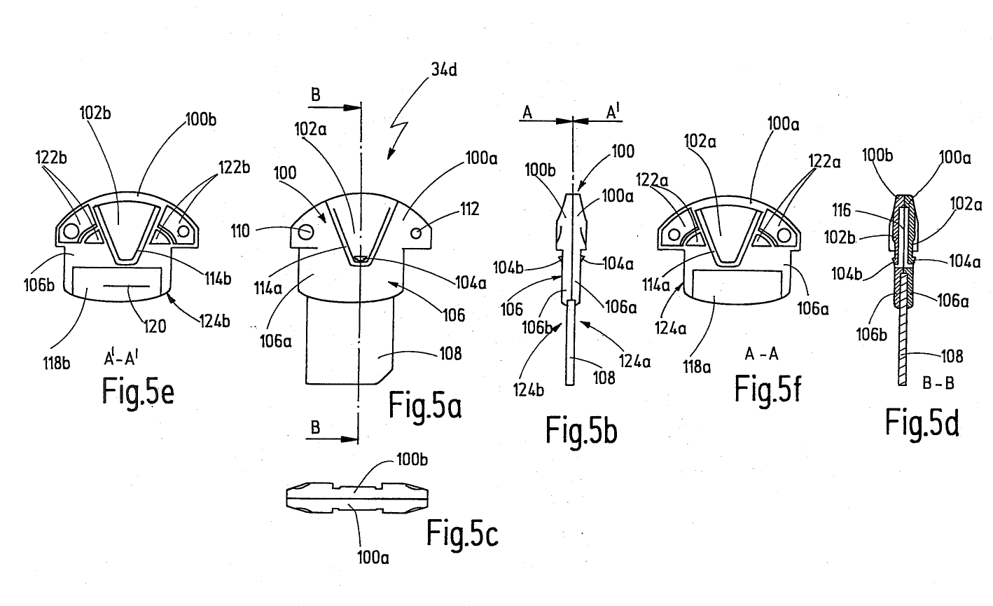

FIG. 5, which comprises the figure elements 5a, 5b, 5c, 5d, 5e, 5f, shows a second exemplary embodiment of the data storage medium by means of various views and sectional illustrations.

Figure element 5a shows a plan view of a data storage medium 34d. The data storage medium 34d has a grip 100, from which figure element 5a shows a grip element 100a. The grip element 100a has a mounting element 102a fitted to it. The mounting element 102a has a latching lug 104a. In addition, the data storage medium 34d has a carrier element 106, from which figure element 5a shows the half 106a which is visible in this illustration. The carrier element 106 carries a memory element 108. The memory element 108 is a commercially available memory card, for example an SD card. The grip element 100a, the mounting element 102a and the carrier element 106 are designed such that the mounting element 102a is largely surrounded by a continuous slot 114a. Hence, the data storage medium 34d also has the mounting element 102a fitted to the grip element 100a so as to be able to move, and can therefore be moved relative to the carrier element 106. The grip element 100a has passage holes 110, 112 which perform the same function and have the same design as those in the data storage medium 34c.

Figure element 5b shows the data storage medium 34d in a side view. The data storage medium 34d comprises two shell elements 124a, 124b. The shell element 124a comprises the grip element 100a and the half 106a of the carrier element 106. The shell element 124b comprises the grip element 100b and the half 106b of the carrier element 106. The grip 100 comprises the two grip elements 100a, 100b. The memory card 108 is retained by the carrier element 106.

Figure element 5c shows the data storage medium 34d in a view from above. Only the two grip elements 100a, 100b are visible in this view on account of the design of the data storage medium.

Figure element 5d shows a sectional illustration of the data storage medium 34d along the sectional line B-B shown in figure element 5a. The grip element 100a has the mounting element 102a fitted to it. The grip element 100b has the mounting element 102b fitted to it. The mounting element 102a has the latching lug 104a. The mounting element 102b has the latching lug 104b. Both the two grip elements 100a, 100b and the two mounting elements 102a, 102b are designed such that a cavity 116 is produced between the two mounting elements 102a, 102b. This cavity 116 merges into the slot 114a shown in figure element 5a. On account of the cavity 116, the two mounting elements 102a, 102b can be moved towards one another when an appropriate force is applied. The memory card 108 is partially encompassed by the two halves 106a, 106b of the carrier element 106.

Figure element 5e shows a plan view of a shell element 124b of the data storage medium 34d. This plan view corresponds to the view from direction A′ onto the sectioned data storage medium 34d when the latter is sectioned along the sectional line shown in figure element 5b. The shell element 124b comprises the grip element 100b, the mounting element 102b and the half 106b of the carrier element 106. The half 106b of the carrier element 106 has a cutout 118b which is used to hold the memory card 108. The cutout 118d has a linear elevation 120 embedded in it which engages in a groove in the memory card 108. This ensures that the memory card 108 which can be pushed into the carrier element 106 is mounted robustly in the carrier element 106. Depressions 122b are arranged in the region of the grip element 100b. The mounting element 102b is surrounded by a continuous slot 114b, which likewise merges into the cavity 116. In terms of functionality, the slot 114b corresponds to the slot 114a.

Figure element 5f shows a plan view of a shell element 124a of the data storage medium 34d. This plan view corresponds to the view from direction A onto the sectioned data storage medium 34d when the latter is sectioned along the sectional line shown in figure element 5b. The shell element 124a comprises the grip element 100a, the mounting element 102a and the half 106a of the carrier element 106. The mounting element 102a is surrounded by the gap 114a. The carrier element 106a has a cutout 118a which is used to hold the memory card 108. Depressions 122a are embedded in the region of the grip element 100a. When the two shell elements 124a, 124b are joined, the depressions 122a, 122b produce cavities. Overall, less material is thus required for manufacturing the data storage medium 34d.

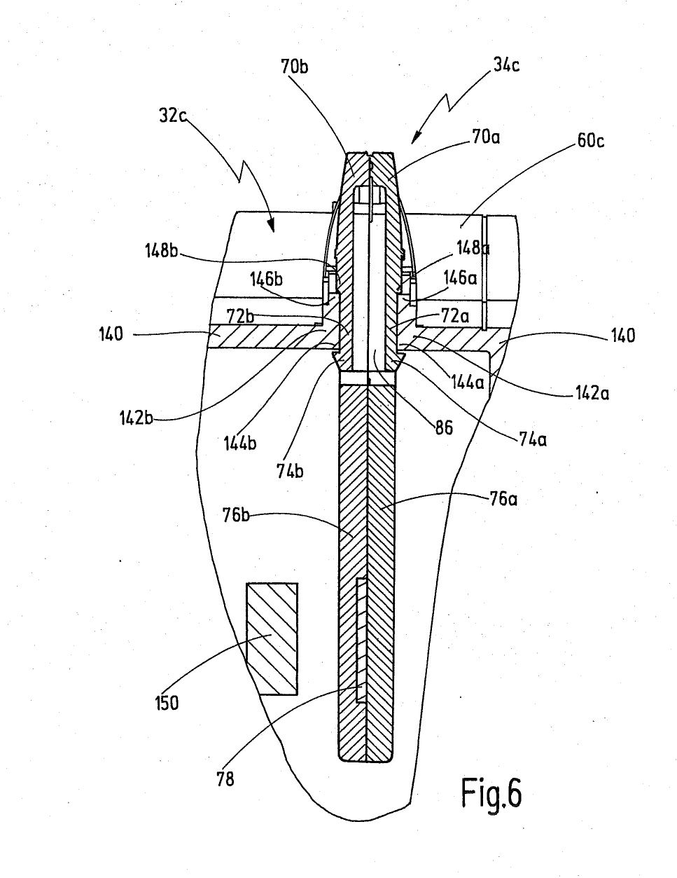

FIG. 6 shows a sectional illustration of the data storage medium 34c mounted in a holding unit 32c. The holding unit 32c is part of a housing 60c of the safety controller 1 or of a subcomponent 10, 10a, 10b of the safety controller 1. The holding unit 32c comprises two retaining elements 142a, 142b embedded in the housing wall 140. The two retaining elements 142a, 142b are arranged at an interval from one another such that an opening is produced in the housing wall 140, through which the data storage medium 34c can be introduced. The retaining element 142a has a latching edge 144a and a retaining edge 146a at an interval therefrom. The retaining element 142b has a latching edge 144b and a retaining edge 146b at an interval therefrom. The mounting element 72a of the data storage medium 34c has the latching lug 74a already described and a securing edge 148a at an interval therefrom. The mounting element 72b has the latching lug 74b already described and a securing edge 148b at an interval therefrom. The two mounting elements 72a, 72b and the two retaining elements 142a, 142b form a latching apparatus. Once the data storage medium 34c has been inserted into the holding unit 32c completely, the latching lug 74a engages behind the latching edge 144a, and the latching lug 74b engages behind the latching edge 144b. In addition, the securing edge 148a is supported on the retaining edge 146a, and the securing edge 148b is supported on the retaining edge 146b. This produces a form-fit connection by means of which the data storage medium 34c is mounted on the holding unit 32c. An appropriately short interval between the two retaining elements 142a, 142b allows the mounting elements 72a, 72b to be retained by the retaining elements 142a, 142b under initial tension when the data storage medium 34c has been introduced into the holding unit 32c completely. In this case, the data storage medium 34c is retained by the holding unit 32c on account of a form-fit connection and a force-fit connection.

As can be seen from the illustration in FIG. 6, the latching lugs 74a, 74b have a bevelled profile. This results in the latching apparatus latching into the holding unit 32c independently when the data storage medium 34c is introduced. By contrast, when the data storage medium 34c is removed, the latching apparatus needs to be unlatched first of all by pushing together the two mounting elements 72a, 72b. Preferably, the bevelled profile is in triangular form, as shown. As an alternative to the bevelled profile, the two latching lugs 74a, 74b may also have a profile in which the boundary line runs parallel to the longitudinal axes of the two halves 76a, 76b of the carrier element 76. In this case, this is a rectangular profile. This rectangular profile results in introduction of the data storage medium 34c into the holding unit 32c first of all requiring the two mounting elements 72a, 72b to be pushed together so that the data storage medium can be introduced into the holding unit in the first place.

As can also be seen from the illustration in FIG. 6, the mounting element 72a and the grip element 70a are of integral design. Similarly, the mounting element 72b and the grip element 70b are of integral design. This results in play which adversely affects the operation of the latching apparatus being reduced to a minimum degree. As an alternative to the integral design, the mounting elements 72a, 72b may also be fitted to the relevant grip element 70a, 70b detachably. In this case, although additional measures are required in order to reduce play which adversely affects the operation of the latching apparatus, it is advantageous that mounting elements that are declining in their operation can be replaced when needed.

Reference numeral 150 denotes a transfer unit which can be used to receive data stored on the transponder 78 and to transfer data to the transponder 78 in a non-contact manner. The transfer unit 150 may be part of an input/output unit 18, 18a, 18b. Alternatively, it may be an independent unit which is connected upstream of the input/output unit 18, 18a, 18b.

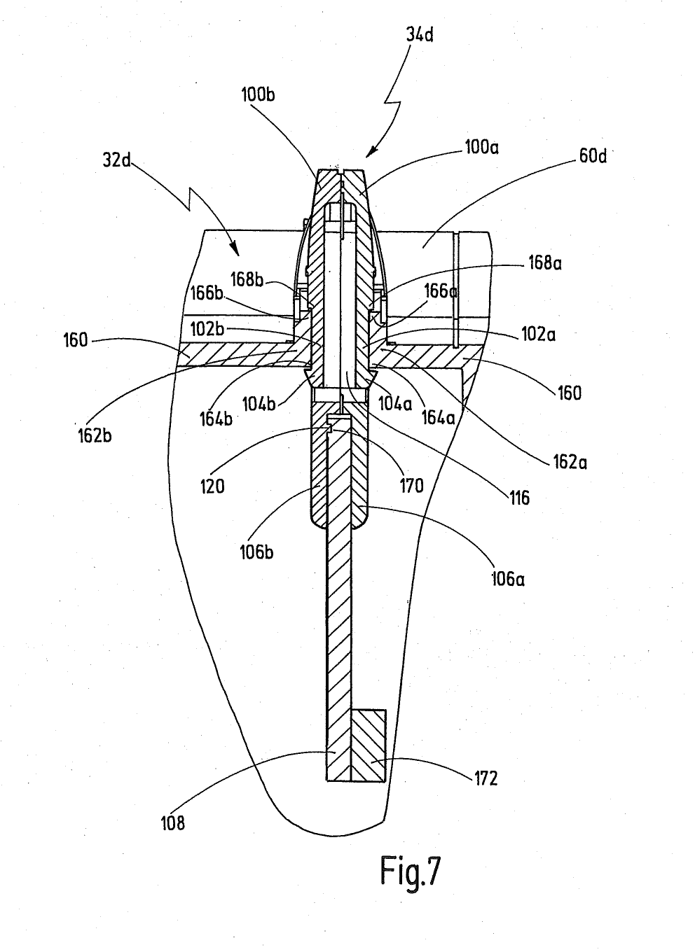

FIG. 7 shows a sectional illustration of the data storage medium 34d mounted in a holding unit 32d. The holding unit 32d is part of a housing 60d of the safety controller 1 or of a subcomponent 10, 10a, 10b of the safety controller 1. The holding unit 32d is designed from two retaining elements 162a and 162b embedded in the housing wall 160. In this case, the two retaining elements 162a, 162b are at an interval from one another such that an opening is produced, into which the data storage medium 34d can be introduced. The retaining element 162a has a latching edge 164a and a retaining edge 166a at an interval therefrom. The retaining element 162b has a latching edge 164b and a retaining edge 166b at an interval therefrom. The mounting element 102a has the latching lug 104a already described and a securing edge 168a at an interval therefrom. The mounting element 102b has the latching lug 104b already described and a securing edge 168b at an interval therefrom. The two mounting elements 102a, 102b and the retaining elements 162a, 162b interacting therewith form a latching apparatus. Once the data storage medium 34d has been introduced into the holding unit 32d completely, the latching lug 104a engages behind the latching edge 164a, and the latching lug 104b engages behind the latching edge 164b. In addition, the securing edge 168a is supported on the retaining edge 166a, and the securing edge 168b is supported on the retaining edge 166b. This produces a form-fit connection which mounts the data storage medium 34d on the holding unit 32d. For the combination of the form-fit connection and a force-fit connection, reference is made to the comments made in connection with FIG. 6.

The two latching lugs 104a, 104b have the bevelled profile already described in connection with FIG. 6. For the data storage medium 34d too, it is also conceivable for the two latching lugs 104a, 104b to have the rectangular profile already described in connection with FIG. 6. Reference is made to the comments regarding the two profiles which were made in connection with FIG. 6.

The half 106b of the carrier element 106 has the linear elevation 120 already described in connection with Figure element 5e, which linear elevation engages in a groove 170 in the memory card 108. In this exemplary embodiment, the memory card 108 undertakes the operation of centering when the data storage medium 34d is introduced into the holding unit 32d, said operation otherwise being undertaken by the carrier element.

Reference numeral 172 denotes a contact-connection unit which has electrical contacts. When the data storage medium 34d is in the state in which it has been fully introduced into the holding unit 32d, when the latching apparatus is latched in, contacts arranged on the memory card 108 touch the contacts on the contact-connection unit 172. This produces an electrically conductive connection and it is possible for the data stored on the memory card 108 to be read. Similarly, data can be transferred from the safety controller 1 or from a subcomponent 10, 10a, 10b of the safety controller 1 to the memory card 108. The contact-connection unit 172 may be part of an input/output unit 18, 18a, 18b. Alternatively, it may be an independent unit which is connected upstream of the input/output unit 18, 18a, 18b.

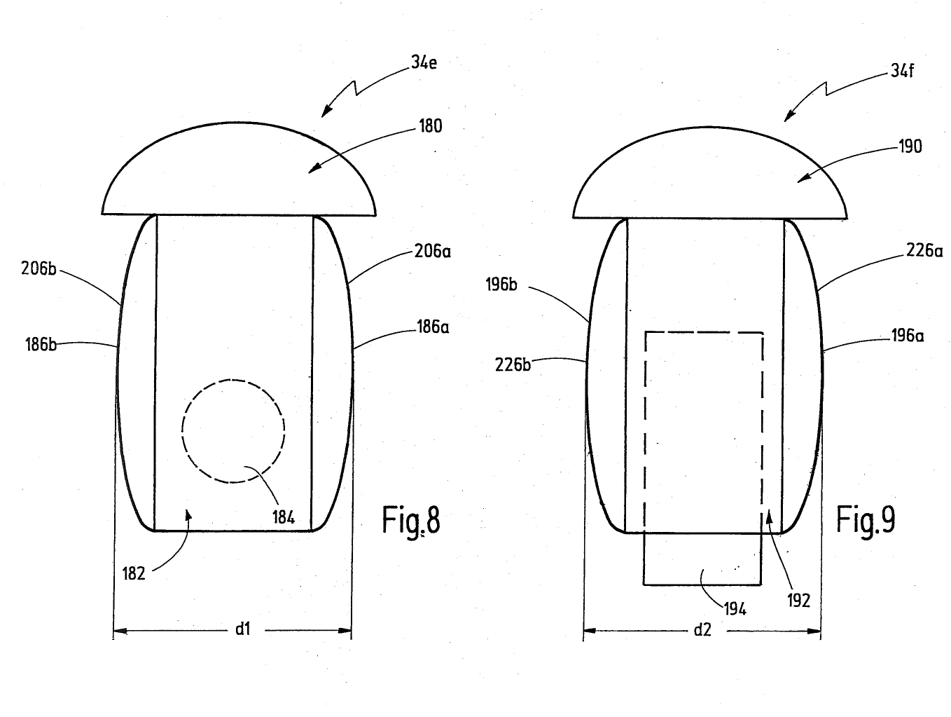

FIG. 8 shows a third exemplary embodiment of the data storage medium.

Reference numeral 34e denotes a data storage medium. Said data storage medium has a grip 180 and a carrier element 182 connected thereto. The carrier element has an embedded memory element 184, which is a transponder for a non-contact data transfer. The data storage medium also has two mounting elements 186a, 186b. These are fitted to the carrier element 182 so as to be able to move. In this case, the mounting elements 186a, 186b and the carrier element 182 may be integrally connected to one another. Alternatively, the mounting elements 186a, 186b may also be connected to the carrier element 182 detachably. The two mounting elements 186a, 186b are in arcuate and elastic form. In FIG. 8, they adopt a position of rest in which the contact areas 206a, 206b thereof are at an interval d1.

FIG. 9 shows a fourth exemplary embodiment of the data storage medium.

Reference numeral 34f denotes a data storage medium. Said data storage medium has a grip 190 and a carrier element 192 fitted thereto. The carrier element 192 carries a memory element 194, which is a commercially available memory card, for example an SD card. The data storage medium also has two mounting elements 196a, 196b which are fitted to the carrier element 192 so as to be able to move. The two mounting elements 196a, 196b may be integrally connected to the carrier element 192. Alternatively, they may also be connected to the carrier element 192 detachably. The two mounting elements 196a, 196b are in arcuate and elastic form. In FIG. 9, they adopt a position of rest in which their contact areas 226a, 226b are at an interval d2. The memory card 194 is partially encompassed by the carrier element 192 such that the contact elements of said memory card are situated outside the carrier element 192.

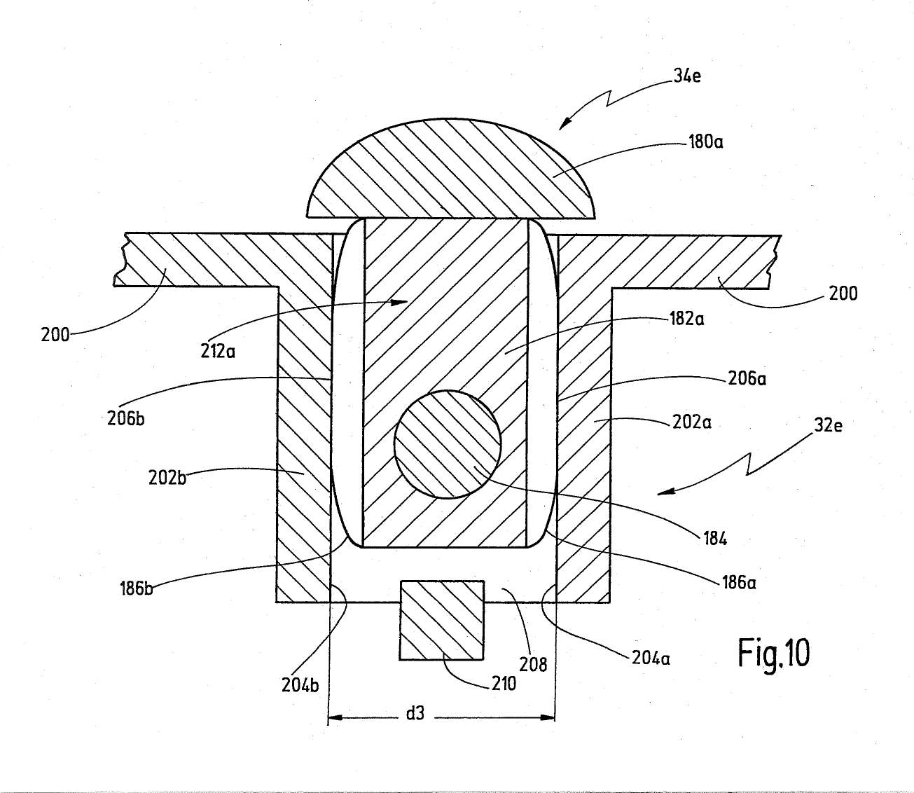

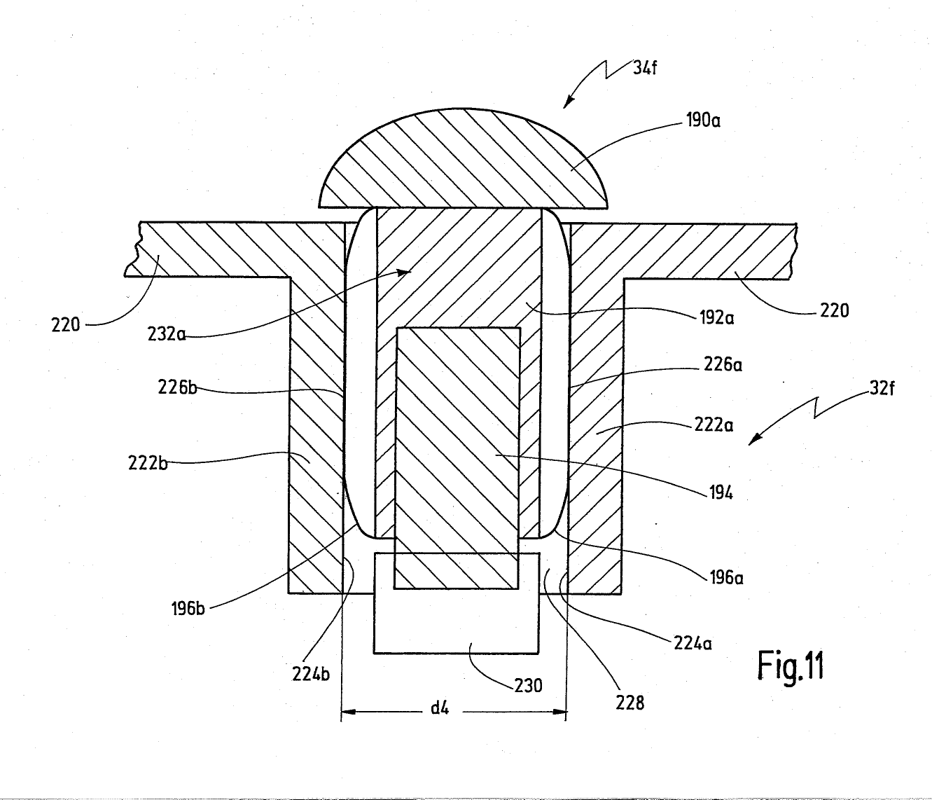

FIG. 10 shows the data storage medium 34e mounted on a holding unit 32e. The holding unit 32e is part of a housing of a safety controller 1 or of a subcomponent 10, 10a, 10b of the safety controller 1. The holding unit 32e is formed by two retaining elements 202a, 20b embedded in the housing wall 200. The two retaining elements 202a, 202b are at an interval from one another such that the data storage medium 34e can be pushed into the resultant free space. The retaining element 202a has a contact area 204a, and the retaining element 202b has a contact area 204b. Once the data storage medium 34e has been pushed into the holding unit 32e, the contact area 206a of the mounting element 186a touches the contact area 204a, and the contact area 206b of the mounting element 186b touches the contact area 204b. The interval between the two contact areas 204a, 204b is denoted by d3. This interval is shorter than the interval d1. When the data storage medium 34e is introduced into the holding unit 32e, the two mounting elements 186a, 186b are pushed together and move in the direction of the carrier element 182. As a result, a force is produced between the contact areas 206a and 204a and the contact areas 206b and 204b in pairs. These forces retain the data storage medium 34e in the holding unit 32e. Overall, this type of mounting and the resultant form of the holding unit 32e and of the mounting elements 186a, 186b are what are known as a clamping apparatus.

The holding unit 32e also has a wall element 208 mounted on the two retaining elements 202a, 202b. The holding unit 32e is therefore in the form of a recess or shaft which is open at one end.

Reference numeral 210 denotes a transfer unit which can be used to transfer the data stored on the memory element 184 to the safety controller 1 or to a subcomponent 10, 10a, 10b of the safety controller 1. Similarly, the transfer unit 210 can be used to transfer data to the memory element 184. The transfer unit 210 may be part of an input/output unit 18, 18a, 18b. Alternatively, it may be an independent unit which is connected upstream of the input/output unit 18, 18a, 18b.

Like the two data storage media 34c, 34d, the data storage medium 34e is also designed from two shell elements 212a, 212b. In FIG. 10, the sectional illustration has been chosen such that the shell element 212a is shown. This shell element comprises a grip element 180a and a half 182a of the carrier element 182. The half 182a has a depression into which the transponder 184 has been embedded. The transponder 184 may be what is known as an RFID transponder.

The retaining elements 202a, 20b and the mounting elements 186a, 186b are therefore in a form such that the data storage medium 34e is mounted on the holding unit 32e by a force-fit connection produced in pairs between said elements. The arcuate and elastic mounting elements 186a, 186b are pushed together when the data storage medium 34e is introduced into the holding unit 32e, and they therefore abut the retaining elements 202a, 202b, which produces the force-fit connection.

FIG. 11 shows the data storage medium 34f mounted on a holding unit 32f. The holding unit 32f is part of the housing of a safety controller 1 or of a subcomponent 10, 10a, 10b of the safety controller 1. The holding unit 32f is formed by two retaining elements 222a, 222b embedded in the housing wall 220. In this case, the two retaining elements 222a, 222b are at an interval from one another such that a free space is produced in which the data storage medium 34f can be introduced. The retaining element 222a has a contact area 224a. The retaining element 222b has a contact area 224b. Once the data storage medium 34f has been pushed into the holding unit 32f, the contact area 226a of the mounting element 196a touches the contact area 224a, and the contact area 226b of the mounting element 196b touches the contact area 224b. The interval between the two contact areas 224a, 224b is denoted by d4. This interval is shorter than the interval d2. As a result, when the data storage medium 34f is introduced into the holding unit 32f, the two arcuate and elastic mounting elements 196a, 196b are pushed together. The contact area 226a of the mounting element 196a abuts the contact area 224a of the retaining element 222a. The contact area 226b of the mounting element 196b abuts the contact area 224b of the retaining element 222b. A force-fit connection is produced between the mounting elements 196a, 196b and the retaining elements 222a, 222b. Overall, a clamping apparatus is on hand. Details regarding the principal of action of a clamping apparatus can be taken from the comments made in this regard in connection with FIG. 10.

The holding unit 32f also has a wall element 228 which is connected to the retaining elements 222a, 222b. The holding unit 32f is therefore in the form of a recess or shaft which is open at one end.

The reference numeral 230 denotes a contact-connection unit. Said contact unit has electrical contacts. Once the data storage medium 34f has been introduced into the holding unit 32f completely, contacts arranged on the memory card 194 touch the contacts of the contact unit 230. An electrical connection is therefore produced which can be used to transfer the data stored on the memory card 194 to a safety controller 1 or to a subcomponent 10, 10a, 10b of the safety controller 1. Similarly, said electrical connection can be used to transfer data to the memory card 194.

The data storage medium 34f is designed from two shell elements 232a, 232b. FIG. 11 shows the shell element 232a in line with the chosen sectional illustration. Said element comprises a grip element 190a and a half 192a of the carrier element 192. The half 192a has a cutout into which the memory card 194 has been at least partially embedded. The shell element 232a has a linear elevation—not shown—which engages in a groove in the memory card 194. The memory card 194 is therefore robustly connected to the carrier element 192.

For the data storage medium 34f, the following applies: the two mounting elements 196a, 196b may be of single-part design and mounted on one of the two shell elements 232a, 232b. Similarly, it is conceivable for the two mounting elements 196a, 196b to be of two-part design, with one respective part being fitted to each of the two shell elements 232a, 232b. If the mounting elements 196a, 196b are mounted on the carrier element 192 detachably, they may be in the form of thin, bent metal platelets. A similar situation applies to the data storage medium 34f.

The data stored on the memory elements 78, 108, 184, 194 can be classified as follows: the access authorization data, which describe the access authorization for the safety controller 1 or for at least one subcomponent 10, 10a, 10b of the safety controller 1, are data which describe or influence the state of the safety controller 1 or of at least one subcomponent 10, 10a, 10b. When access authorization has been given as appropriate, the safety controller or a subcomponent can be changed over from a normal mode, in which the control tasks prescribed by a user program are performed, to a special mode, in which protected devices arranged in the safety controller are specifically bypassed and hence the protective action thereof is cancelled. In this special mode, an operator is able to work specifically, for example to carry out adjustment work on the machine controlled by the safety controller. Depending on the implemented idea of the access authorization, the memory elements 78, 108, 184, 194 store different data. In a first idea, the memory elements 78, 108, 184, 194 store only digits. These digits are transferred to the safety controller 1 or to at least one subcomponent 10, 10a, 10b of the safety controller 1, where they are evaluated. The safety controller 1 or subcomponent 10, 10a, 10b stores, for each digit, an access authorization which is linked thereto, said access authorizations differing in terms of the respectively granted opportunity to influence the machine or installation. Thus, a first access authorization may allow just slight influencing, for example just the alteration of the parameterization. By contrast, a second access authorization may grant very wide-ranging influencing, for example programming of the basic system of the controlled machine or installation. In a second idea, the access authorizations associated with the data storage medium are stored directly in the memory element 78, 108, 184, 194. These are then transferred to the safety controller 1 or to a subcomponent 10, 10a, 10b.

The address data, which describe the address of at least one subcomponent 10, 10a, 10b of the safety controller 1, are data which describe or influence a property of a subcomponent. The address assigns a subcomponent an attribute which allows it to be addressed by other subcomponents. The maintenance data, which describe the servicing or inspection work to be carried out for the safety controller 1 or for at least one subcomponent 10, 10a, 10b of the safety controller 1, are data which describe or influence the state of said safety controller or subcomponent. These may be the threshold values with which counters implemented by means of programming in the safety controller or in the subcomponent are compared in order to be able to assess the state of the safety controller or subcomponent in terms of servicing or inspection work which is to be carried out. In the case of the user program which prescribes the control tasks to be carried out by the safety controller, these are data which describe or influence the property of the safety controller.

The data stored on the memory element 78, 108, 184, 194 may also be what are known as curves or configuration data which are used in the field of drive engineering.

Even if the various exemplary embodiments of the data storage medium have been described above in connection with the safety controller, this is not intended to have any limiting effect. The data storage medium can be used in any control systems, i.e. in standard controllers or in safety controllers or in hybrid control systems, which have a standard-control and a safety-control component. This stems from the fact that the mechanical functionality of the data storage medium, particularly the movable mounting element which distinguishes it, is independent of the embodiment of the control system. For this reason, it is also possible to use the data storage medium in any data receiving device.

It goes without saying that the features cited above and those yet to be mentioned below can be used not only in the respectively indicated combination but also in other combinations or on their own without departing from the scope of the present invention.

What is claimed is:

1. A safety controller for controlling a hazardous machine, comprising:
two redundant processors for processing input signals from external sensors and for generating control signals for external actuators, said two redundant processors being connected to each other in order to monitor each other,
an input and output unit for receiving the input signals from said external sensors and for transmitting the control signals to the external actuators, said input and output unit being connected to said redundant processors,
a data storage medium having a carrier element which carries a memory element, and having at least one mounting element which is able to move relative to the carrier element,
a holding unit for detachably holding the data storage medium, the holding unit having at least one retaining element, and
a data transfer unit configured to transfer data to and from the data storage medium, while said data storage medium is held by the holding unit,
wherein the mounting element has a latching lug and a securing edge at a distance from said latching lug, and the retaining element has a latching edge and a retaining edge at a distance from said latching edge, with the latching lug being configured to engage behind the latching edge and the retaining edge being configured to support the securing edge in order to establish a form-fit connection for holding the data storage medium by the holding unit in a self-locking manner.

2. The safety controller of claim 1, wherein the memory element stores data that define a characteristic of the controller system.

3. The safety controller of claim 1, wherein said data comprises at least one of the following: access authorization data defining an authorization to access the controller, address data defining a communication address of the controller, a user program to be executed by the redundant processors, and maintenance data defining servicing or inspection work to be carried out on the controller.

4. The safety controller of claim 1, wherein the holding unit comprises a recess configured to receive the carrier element and the memory element.

5. The safety controller of claim 1, wherein the latching lug has spring tension and a bevelled tip, such that the mounting element automatically passes by the retaining element when the carrier element is introduced into the holding unit.

6. The safety controller of claim 5, wherein the mounting element automatically latches in a rest position, when the latching lug has passed by the retaining element.

7. The safety controller of claim 1, wherein the data storage medium further has a grip element to which the mounting element is moveably connected.

8. The safety controller of claim 7, wherein the grip element and the mounting element are integrally connected to one another.

9. The safety controller of claim 1, wherein the memory element is a trans-ponder configured for a non-contact data transfer.

10. The safety controller of claim 1, wherein the memory element is a memory card that partially protrudes from the carrier element.

11. The safety controller of claim 10, wherein the memory card has a groove and the carrier element has a linear elevation engaging into the groove for realisably securing the memory card to the carrier element.

12. The safety controller of claim 1, wherein the data storage medium has two mounting elements arranged in mirror-like fashion to one another.

13. The safety controller of claim 1, wherein the data storage medium comprises two shell elements connected to each other in order to encompass the memory element.

14. A safety controller for controlling a hazardous machine, comprising:
two redundant processors for processing input signals from external sensors and for generating control signals for external actuators, said two redundant processors being connected to each other in order to monitor each other,
an input and output unit for receiving the input signals from said external sensors and for transmitting the control signals to the external actuators, said input and output unit being connected to said redundant processors,
a data storage medium having a carrier element which carries a memory element, and having at least one mounting element which is able to move relative to the carrier element,
a holding unit for detachably holding the data storage medium, the holding unit having at least two retaining elements arranged at a distance to one another, and
a data transfer unit configured to transfer data to and from the data storage medium, while said data storage medium is held by the holding unit,
wherein the mounting element is spring-biased in order to establish a force-fit connection when the mounting element is pushed between the at least two retaining elements and abuts against the retaining elements.

15. The safety controller of claim 14, wherein the mounting element is made of an elastic material.

16. The safety controller of claim 14, wherein the mounting element has an arcuate form.

17. The safety controller of claim 14, wherein the mounting element is moveably connected to the carrier element.

18. The safety controller of claim 14, wherein the mounting element is detachably connected to the carrier element.

19. The safety controller of claim 14, wherein the memory element stores data that define a characteristic of the controller system.

20. The safety controller of claim 14, wherein the data storage medium further has a grip element to which the carrier element is connected.
